(19) United States
(12) Patent Application Publication
(10) Pub. No.: US 2011/0119312 A1
(43) Pub. Date: May 19, 2011

(54) SYSTEM AND METHOD FOR AUTOMATED SCALABILITY OF N-TIER COMPUTER APPLICATIONS

(76) Inventors: ARJUN CHOPRA, San Francisco, CA (US); Sundar Subramaniam, Cambridge, MA (US)

(21) Appl. No.: 12/945,916

(22) Filed: Nov. 15, 2010

Related U.S. Application Data
(60) Provisional application No. 61/261,355, filed on Nov. 15, 2009.

(51) Int. Cl. G06F 9/44; G06F 17/30

(52) U.S. Cl. 707/802; 717/171; 707/E17.044

(57) ABSTRACT

A system and method for providing automatic horizontal and vertical scalability for n-tier computer applications in an n-tier computer application infrastructure is disclosed. The n-tier computer application infrastructure includes an interface, an application server and a data store. In one embodiment, major functional aspects of an n-tier computer application are identified by analyzing an n-tier computer application by a cloud engine. Further, major database aspects in the data store are identified by analyzing a database schema and a database application logic used in the data store by the cloud engine. Furthermore, a reconfigured automatically scalable n-tier computer application infrastructure that is horizontally and vertically scalable is generated based on the identified major functional aspects, the identified major database aspects and the n-tier computer application usage needs.

This application claims priority under 35 U.S.C 119(e) to U.S. Provisional Application No. 61/261,355 entitled “A system that allows existing n-tier applications to be de-coupled, service-enabled and scaled in an automated manner, based on policy-controlled, self-correcting management systems” by Chopra et al. filed on Nov. 15, 2009, which is incorporated herein by reference.

### FIELD OF TECHNOLOGY

Embodiments of the present invention relate to the field of computer applications. More particularly, embodiments of the present invention relate to scalability of n-tier computer applications.

### BACKGROUND

Existing, n-tier computer application infrastructures typically consist of logical blocks that are, referred to as interface, application server, data store, and the like. Generally, all these blocks are tightly coupled together in the n-tier computer application infrastructures. However, with the existing n-tier computer application infrastructures, it is difficult and cumbersome to scale an n-tier computer application to support as the users, transactions and/or complexity increases over time as the volume of the user base increases, the number of transactions grows, and/or the complexity significantly increases. While the n-tier computer application can use more powerful machines to scale (referred to as ‘Vertical Scaling’), there is a natural limit to the power of the machine that can be used. Furthermore, the cost of upgrading the machines can be significant. Another existing technique to scale is by adding more machines and computing power, especially at the bottleneck areas of the n-tier computer application. This is referred to as ‘Horizontal Scaling’. However, the existing n-tier computer application infrastructures require considerable software development effort and time to rewrite the n-tier computer application to scale to support these Horizontal Scaling efforts. The reason being, that one has to read and understand the current code in the n-tier computer application and then rewrite the code in the application and may also require changing the computer application architecture to provide the needed horizontal scalability, which can require significant software development effort and time. Further, this development effort may need to be repeated as and when new functionalities are added, which requires scaling as well.

### BRIEF DESCRIPTION OF THE DRAWINGS

Embodiments of the present invention are illustrated by way of an example and not limited to the figures of the accompanying drawings, in which like references indicate similar elements and in which:

FIG. 1 illustrates a block diagram of an n-tier computer application infrastructure, in the context of the invention.

FIG. 2 illustrates a system view of the n-tier computer application infrastructure, according to one embodiment.

FIG. 3 is block diagram illustrating horizontal scalability of data store by a cloud engine in the n-tier computer application infrastructure, such as those shown in FIG. 2, according to one embodiment.

FIG. 4 is a block diagram illustrating horizontal scalability of n-tier computer application server by the cloud engine in the computer application infrastructure, such as those shown in FIG. 2, according to one embodiment.

FIG. 5 illustrates major functional components of the cloud engine and a cloud service layer of the n-tier computer application infrastructure, such as those shown in FIG. 2, according to one embodiment.

FIG. 6 illustrates the cloud engine and the reconfigured automatically scalable n-tier computer application infrastructure, according to one embodiment.

FIG. 7 illustrates a cloud management server connecting to the first cloud service layer and the second cloud service layer, according to one embodiment.

FIG. 8 is a process flow illustrating automatic scalability for n-tier computer applications, according to one embodiment.

Other features of the present embodiments will be apparent from the accompanying drawings and from the detailed description that follows.

### DETAILED DESCRIPTION

A system and method for providing automatic scalability for n-tier computer application infrastructure is disclosed. In the following detailed description of the embodiments of the invention, reference is made to the accompanying drawings that form a part hereof, and in which are shown, by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

The term “web service” refers to an application that can be accessed over a network, such as IP network. The web service receives inputs, conducts operations and computations as needed and returns the results. The web service is not restricted to any particular machine and can be located anywhere as long as it can be accessed via the network.

The term “web application” is considered to be a collection of one or more “web services”. The term “n-tier” refers to greater than or equal to one tier. The term “refactoring” refers to the web services, such as rewriting services, joining services and/or separating services.

The present invention automatically decouples, service enables and scales a tightly coupled n-tier computer application infrastructure based on policy control, self-correcting scheme, computer application usage and the like to adopt itself based on user base needs. The present invention provides automatic scalability for n-tier computer application infrastructure.

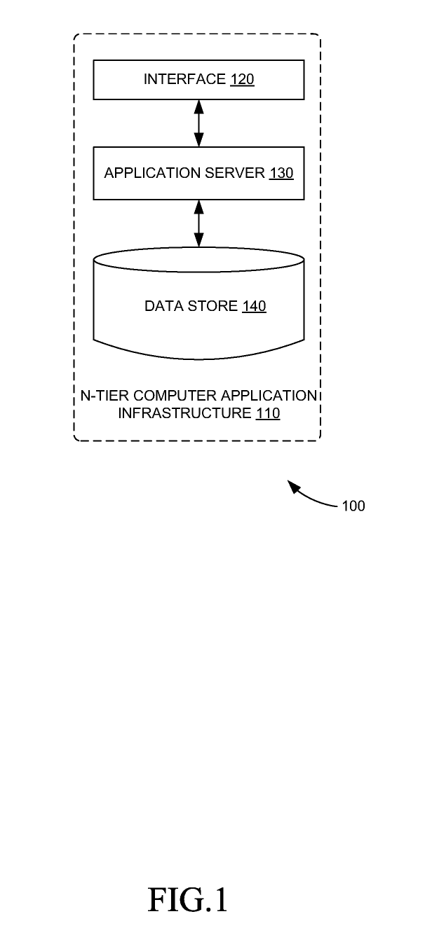

FIG. 1 is a block diagram 100 illustrating an n-tier computer application infrastructure 110, in the context of the invention. Particularly, the n-tier computer application infrastructure 110 includes an interface 120, an application server 130 and a data store 140. The application server 130 further includes an n-tier computer application. The interface 120 may include a web page, which allows a user to interact, enter data or queries, edit data and perform similar actions on the n-tier computer application. The application server 130 processes the data entered by the user via the interface 120. The data store 140 stores any data associated with the n-tier computer application.

The operation of the above n-tier computer application infrastructure 110 is described, for example, using a billing application of a consulting company for keeping track of the payments. For example, a vendor enters the name of a customer, number of hours spent with the customer, the hourly rate for the customer, the due date and the current status (sent, overdue, paid) of the payments and so on using the interface 120. The application server 130 then collects the information provided by the vendor, calculates the total payment due, stores the information and the calculated payment due in the data store 140 and generates a printable invoice. The data store 140 may also include a procedure to check the due date of each payment every morning, and creates a list of overdue invoices.

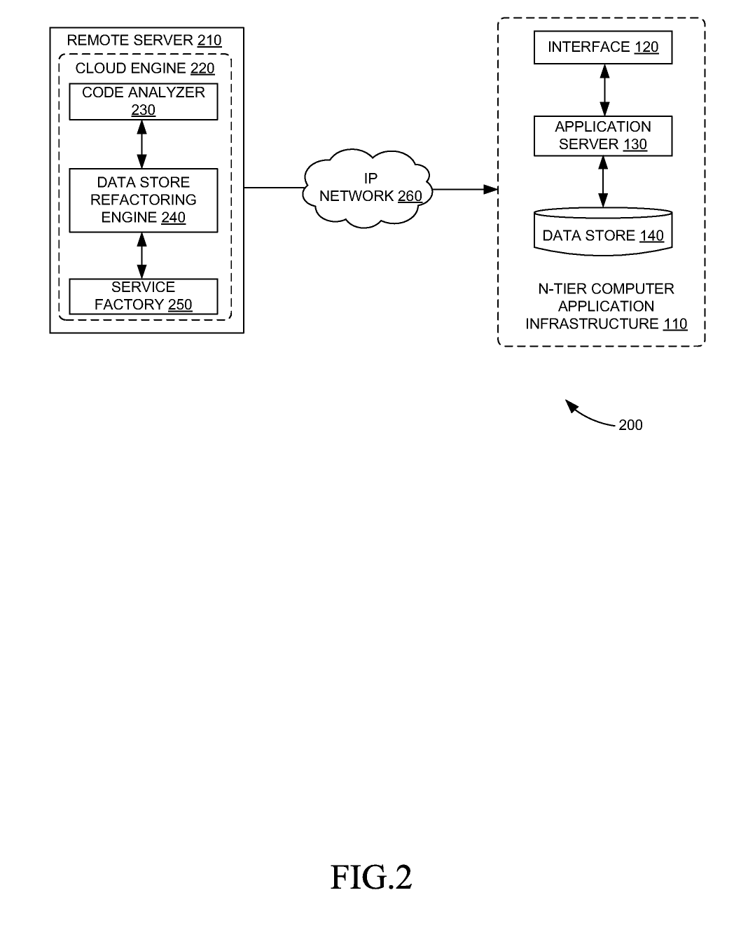

FIG. 2 illustrates a system view 200 of the n-tier computer application infrastructure 110 (also shown in FIG. 1) connected to a remote server 210 via an IP network 260, according to one embodiment. Further, the remote server 210 includes a cloud engine 220. The cloud engine 220 further includes a code analyzer 230, a data store refactoring engine 240 and a service factory 250.

The cloud engine 220 identifies the major functional aspects of the n-tier computer application by interacting with the n-tier computer application infrastructure 110 via the IP network 260. Further, the cloud engine 220 also identifies major database aspects of the data store 140 and generates a reconfigured automatically scalable n-tier computer application infrastructure that is horizontally and vertically scalable based on the identified major functional aspects and the major database aspects.

In operation, the code analyzer 230 analyzes the n-tier computer application to identify major functional aspects of the n-tier computer application residing in the n-tier computer application infrastructure 110. In one embodiment, the code analyzer 230 identifies the major functional aspects of the n-tier computer application by analyzing code of the n-tier computer application. Exemplary major functional aspects can be bottle necks associated with most used parts of the code in the n-tier computer application and the like.

Further, the data store refactoring engine 240 analyzes the data store 140 to identify major database aspects. In one embodiment, the data store refactoring engine 240 identifies the major database aspects in the data store 140 by analyzing the database schema, database application logic, storage formats and structures and any business logic that might exist. Exemplary major database aspects can be bottle necks associated with most used parts of the data store 140 in the n-tier computer application infrastructure 110 and the like.

Furthermore, the service factory 250 generates a reconfigured automatically scalable n-tier computer application infrastructure that is horizontally and vertically scalable based on the identified major functional aspects, the identified major database aspects and the n-tier computer application usage needs.

In our above running consulting company example, the code analyzer 230 may analyze code associated with the billing application in the application server 130 to identify the major functional aspects, such as code associated with collecting invoice data, calculating invoice value on hourly basis, sending the invoice data and invoice value to the data store 140, generating a printable invoice, providing the interface 120 with a list of all existing invoices along with the printable invoice, providing the interface 120 with a list of overdue invoices, and so on.

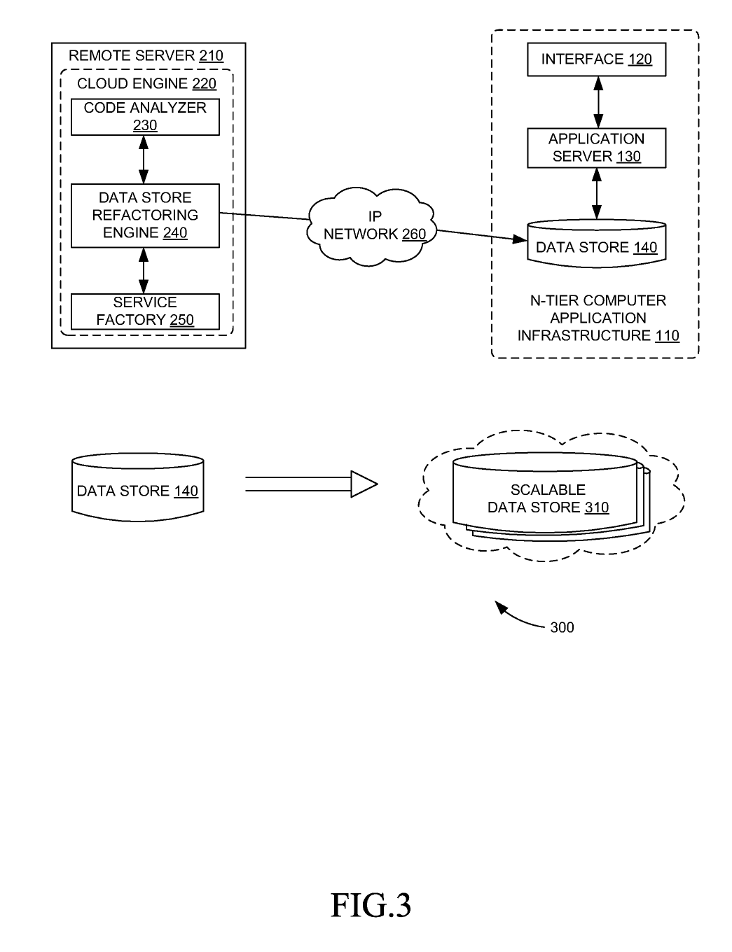

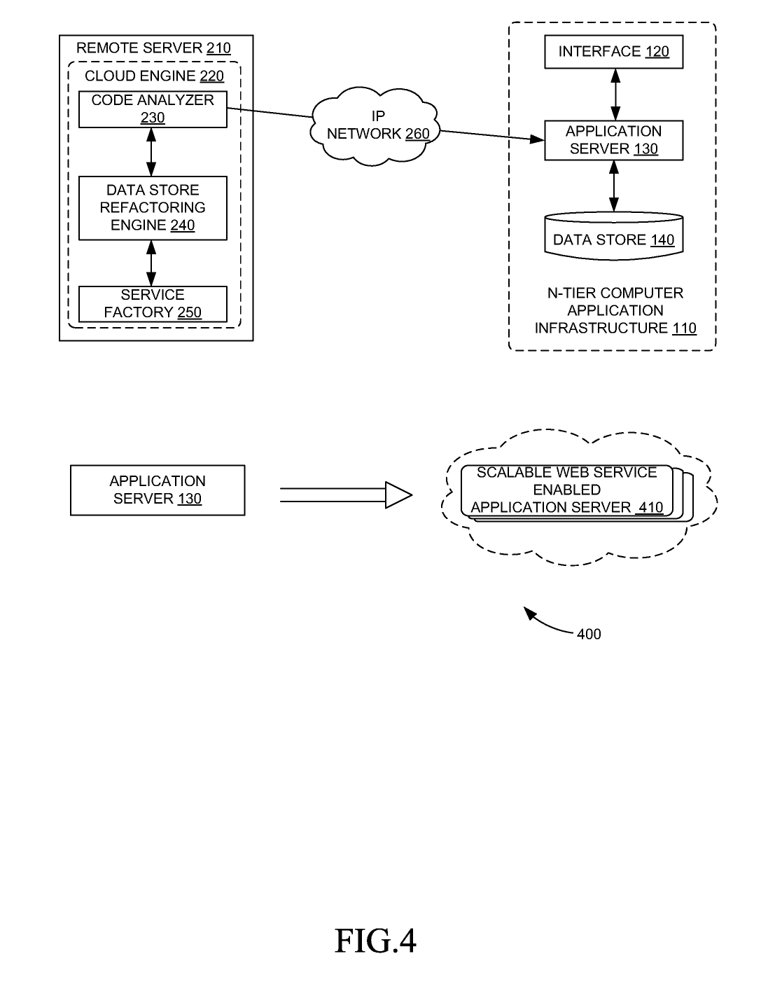

Further, the data store refactoring engine 240 may analyze the data store 140 to identify the major database aspects, such as storing the actual data such as the invoice data and invoice value, running a daily process to check for overdue payments, generating a list of overdue payments every day, providing a list of existing invoices as requested and the like. Furthermore, the service factory 250 may generate services for reconfiguring automatically scalable n-tier computer application infrastructure using the above identified major functional aspects and the major database aspects. The functional aspects of service factory 250 are explained in greater detail with reference to FIGS. 3 and 4.

FIG. 3 is block diagram 300 illustrating horizontal scalability of the data store 140, by the cloud engine 220 (shown in FIG. 2), in the n-tier computer application infrastructure 110 (shown in FIG. 1), according to one embodiment. Particularly, FIG. 3 illustrates the data store refactoring engine 240 for generating a scalable data store 310 by communicating with the data store 140 via the IP network 260.

In one exemplary embodiment, the service factory 250 generates the scalable data store 310 including a database web service for each of the identified major database aspects in the data store 140.

In our above running consulting company example, the data store 140 associated with the billing application may be horizontally scaled by generating a database web service for each of the identified major database aspects. Further, each generated database web service is capable of running independently and may be moved to different machines having different computing powers, connected via a network. The network may include Internet, Ethernet and the like. Furthermore, each of the machines may also be independently scaled based on various parameters such as application usage needs, network traffic, and so on. In addition, the billing application may be vertically scaled by using more powerful machine for each generated database web service.

FIG. 4 is a block diagram 400 illustrating horizontal scalability of the application server 130, by the cloud engine 220 (shown in FIG. 2), in the n-tier computer application infrastructure 110 (shown in FIG. 1), according to one embodiment. Particularly, FIG. 4 illustrates the code analyzer 230 for generating a scalable web service enabled application server 410 by communicating with the application server 130 via the IP network 260.

In one exemplary embodiment, the service factory 250 generates the scalable web service enabled application server 410 including an application web service for each of the identified major functional aspects in the n-tier computer application.

In our above running consulting company example, the application server 130 associated with the billing application may be horizontally scaled by generating an application web service for each of the identified major functional aspects. Further, each generated application web service is capable of running independently and may be moved to different machines having different computing powers, connected via the network. Furthermore, each of the machines may also be independently scaled based on various parameters such as application usage needs, network traffic, and so on. In addition, the billing application may be vertically scaled by using more powerful machine for each generated application web service.

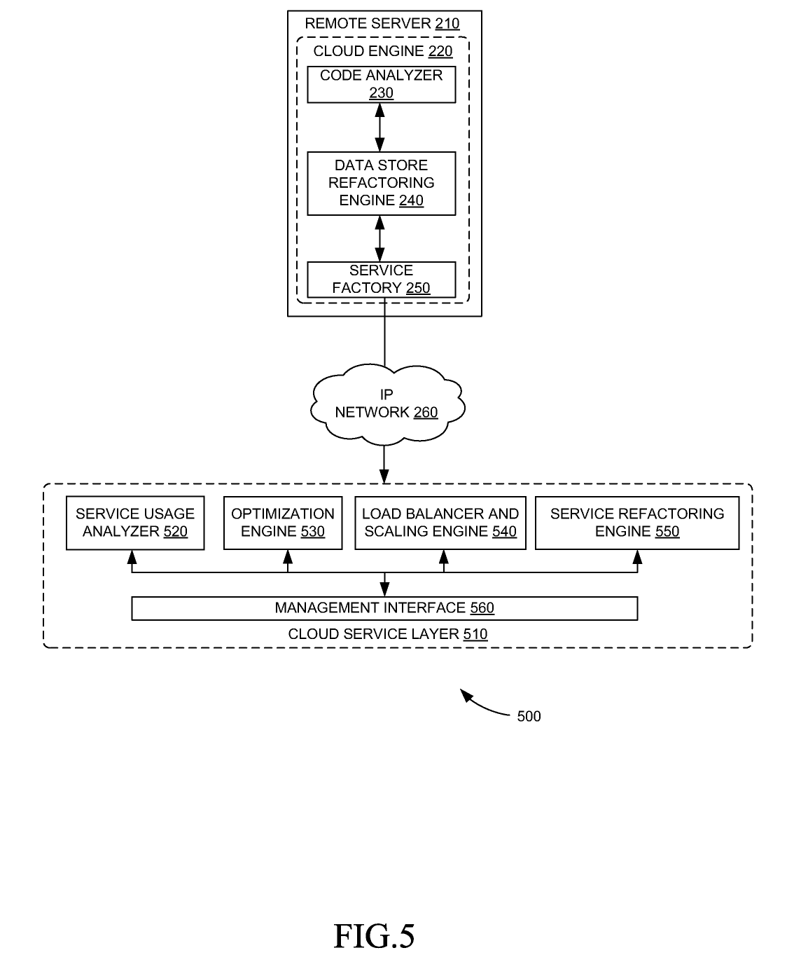

FIG. 5 illustrates major functional components of the cloud engine 220 and a cloud service layer 510 of the n-tier computer application infrastructure 110 (shown in FIG. 2), according to one embodiment. Particularly, the cloud engine 220 is connected to the cloud service layer 510 via the IP network 260. The cloud service layer 510 includes a service usage analyzer 520, an optimization engine 530, a load balancer and scaling engine 540, a service refactoring engine 550 and a management interface 560. As shown in FIG. 5, the management interface 560 is connected to the service usage analyzer 520, the optimization engine 530, the load balancer and scaling engine 540, and the service refactoring engine 550.

The cloud service layer 510 analyzes usage of each of the identified major functional aspects and the identified major database aspects and optimizes the scalable web service enabled application server 410 and the scalable data store 310. Further, the cloud service layer 510 also load balances and scales the scalable web service enabled application server 410 and the scalable data store 310. Furthermore, the cloud service layer 510 service refactors the scalable web service enabled application server 410 and the scalable data store 310.

In operation, the service usage analyzer 520 analyzes usage of each of the identified major functional aspects and the identified major database aspects. The optimization engine 530 optimizes the scalable web service enabled application server 410 and the scalable data store 310 based on predetermined rules and the usage analysis. In one embodiment, the optimization engine 530 continuously reconfigures the cloud service layer 510 to obtain the desired performance.

The load balancer and scaling engine 540 load balances and scales the scalable web service enabled application server 410 and the scalable data store 310 based on the optimization. In one embodiment, the load balancer and scaling engine 540 enables the cloud service layer 510 to deliver optimal performance by including additional physical and virtual resources based on the application usage needs.

The service refactoring engine 550 refactors the scalable web service enabled application server 410 and the scalable data store 310 based on the load balancing and scaling. In one embodiment, the service refactoring engine 550 enables the cloud service layer 510 to create new application web services and/or database web services based on the application usage needs. Further, the service refactoring engine 550 also enables the cloud service layer 510 to combine or refactor the existing application web services and/or database web services to obtain the desired performance.

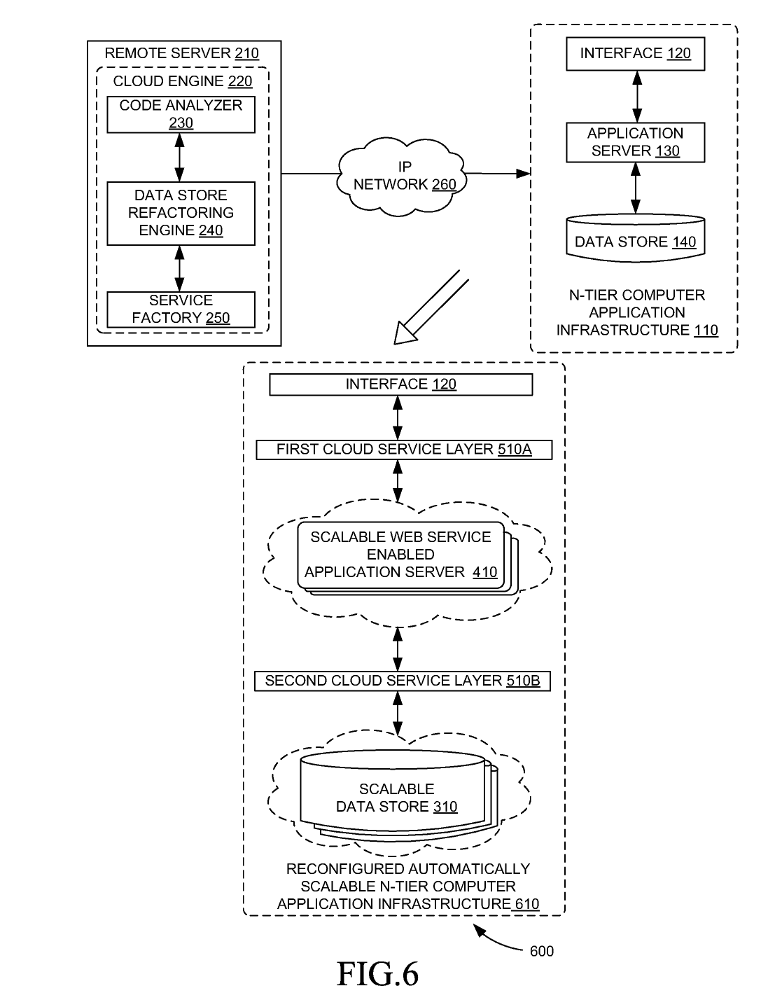

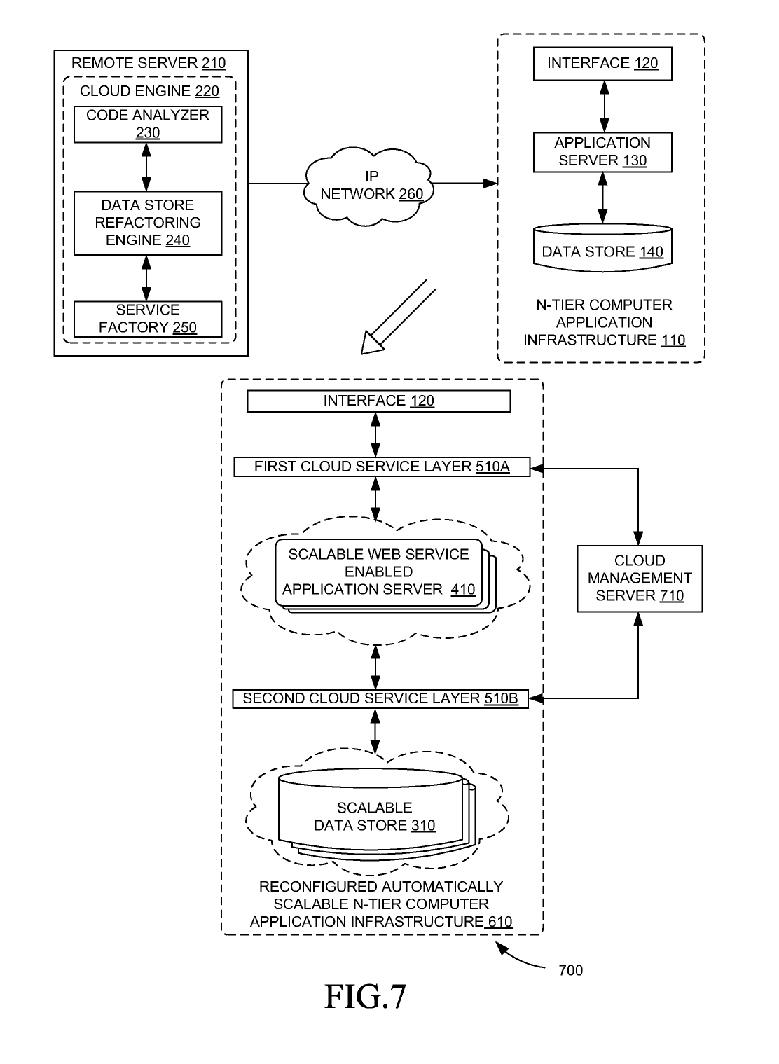

The management interface 560 allows the cloud service layer 510 to be configured in a policy-controlled manner and can be accessed via the IP network 260. The management interface 560 is explained in greater detail with reference to FIG. 7. The cloud service layer 510 is explained with respect to the scalable web service enabled application server 410 and scalable data store 310 in FIG. 6.

FIG. 6 illustrates the cloud engine 220 and the reconfigured automatically scalable n-tier computer application infrastructure 610, according to one embodiment. Particularly, FIG. 6 illustrates the reconfigured automatically scalable n-tier computer application infrastructure 610 generated from the n-tier computer application infrastructure 110. The reconfigured automatically scalable n-tier computer application infrastructure 610 includes the interface 120, a first cloud service layer 510A, the scalable web service enabled application server 410, a second cloud service layer 510B, and the scalable data store 310.

In one embodiment, the first cloud service layer 510A connects the interface 120 with the scalable web service enabled application server 410. The first cloud service layer 510A analyzes usage of each of the identified major functional aspects and optimizes the scalable web service enabled application server 410 based on predetermined rules and the usage analysis. Further, the first cloud service layer 510A load balances and scales the scalable web service enabled application server 410 based on the optimization. Furthermore, the first cloud service layer 510A service refactors the scalable web service enabled application server 410 based on the load balancing and scaling.

Further, the second cloud service layer 510B connects the scalable web service enabled application server 410 and the scalable data store 310. The second cloud service layer 510B analyzes usage of each of the identified major database aspects and optimizes the scalable data store 310 based on predetermined rules and the usage analysis. Further, the second cloud service layer 510B load balances and scales the scalable data store 310 based on the optimization. Furthermore, the second cloud service layer 510B service refactors the scalable data store 310 based on the load balancing and scaling.

In our above running consulting company example, the first cloud service layer 510A and the second cloud service layer 510B may interact with the different machines which may include the application web service and/or the database web service. The cloud engine 220 allows for the above described embodiments to be automated. Further, the cloud engine 220 detects any changes in the application usage and refactors the application web service and/or the database web service as needed.

FIG. 7 illustrates a cloud management server 710 connected to the first cloud service layer 510A and the second cloud service layer 510B, according to one embodiment. The cloud management server 710 may be connected to the first cloud service layer 510A and the second cloud service layer 510B via a network. The service factory 250 generates the management interface 560 (shown in FIG. 5) for the first cloud service layer 510A and the second cloud service layer 510B. The generated management interface 560 resides within the first cloud service layer 510A and the second cloud service layer 510B.

Further, the cloud management server 710 manages the computer application usage in the scalable web service enabled application server 410 and the scalable data store 310 via the first cloud service layer 510A and the second cloud service layer 510B based on the service usage, the optimization information, the load balancing and scaling information and the service refactoring information obtained from the first cloud service layer 510A and the second cloud service layer 510B.

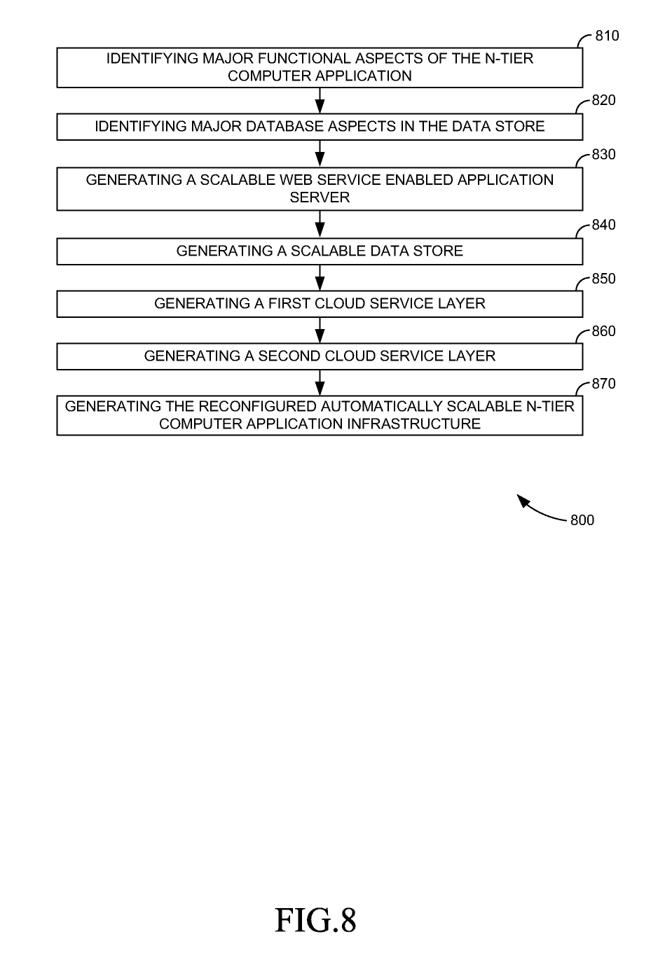

FIG. 8 is a process flow 800 illustrating the automatic scalability of an n-tier computer applications 610 (shown in FIG. 6), according to one embodiment. At step 810, the major functional aspects of the n-tier computer application are identified by analyzing the n-tier computer application by a cloud engine 220. At step 820, the major database aspects of the data store 140 are identified by analyzing the database schema and the database application logic used in the data store 140, by the cloud engine 220, as explained in greater detail in FIG. 2.

At step 830, the scalable web service enabled application server 410 is generated. In these embodiments, the scalable web service enabled application server 410 includes the application web service for each of the identified major functional aspects. The scalable web service enabled application server 410 can be replicated as needed without affecting integrity of the n-tier computer application. This is explained in greater detail in FIG. 4. At step 840, the scalable data store 310 is generated. In these embodiments, the scalable data store 310 includes the database web service for each of the identified major database aspects. The scalable data store 310 can be replicated as needed without affecting integrity of the n-tier computer application, as explained in greater detail in FIG. 3.

At step 850, the first cloud service layer 510A for connecting the interface 120 with the scalable web service enabled application server 410 is generated by the cloud engine 220. At step 860, the second cloud service layer 510B for connecting the scalable web service enabled application server 410 with the scalable data store 310 is generated by the cloud engine 220. At step 870, the reconfigured automatically scalable n-tier computer application 610 that is horizontally and vertically scalable is generated based on the scalable web service enabled application server, the scalable data store, the first cloud service layer and the second cloud service layer. In these embodiments, the scalable web service enabled application server, the scalable data store, the first cloud service layer and the second cloud service layer can run on machines having different computing powers, as explained in greater detail in FIG. 6.

Further, with respect to the above described embodiments with respect to FIG. 8, the usage of each of the identified major functional aspects of the n-tier computer application is analyzed by the first cloud service layer 510A. Further, the scalable web service enabled application server 410 is optimized based on predetermined rules and the usage analysis by the first cloud service layer 510A. Furthermore, the scalable web service enabled application server 410 is load balanced and scaled based on the optimization by the first cloud service layer 510A and the scalable web service enabled application server 410 is refactored based on the load balancing and scaling by the first cloud service layer 510A.

Furthermore, the usage of each of the identified major database aspects of the data store 140 is analyzed by the second cloud service layer 510B. Further, the scalable data store 310 is optimized based on predetermined rules and the usage analysis by the second cloud service layer 510B. Furthermore, the scalable data store 310 is load balanced and scaled based on the optimization by the second cloud service layer 510B and the scalable data store 310 is refactored based on the load balancing and scaling by the second cloud service layer 510B.

Furthermore, the n-tier computer application usage is managed via the first cloud service layer 510A and the second cloud service layer 510B based on service usage, optimization, load balancing and service refactoring of the scalable web service enabled application server 410 and the scalable data store 310, as explained in greater detail in FIG. 5.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A computer implemented method for automatic scalability of an n-tier computer application infrastructure, wherein the n-tier computer application infrastructure includes an interface, an application server and a data store, comprising:
identifying major functional aspects of an n-tier computer application by analyzing an n-tier computer application by a cloud engine;
identifying major database aspects in the data store by analyzing a database schema and a database application logic used in the data store by the cloud engine; and
generating a reconfigured automatically scalable n-tier computer application infrastructure that is horizontally and vertically scalable based on the identified major functional aspects, the identified major database aspects and the n-tier computer application usage needs.

2. The method of claim 1, wherein generating the reconfigured automatically scalable n-tier computer application infrastructure comprises:
generating a scalable web service enabled application server, including an application web service for each of the identified major functional aspects in the n-tier computer application, by the cloud engine that can be replicated as needed without affecting an integrity of the n-tier computer application;
generating a scalable data store, including a database web service for each of the identified major database aspects in the data store, by the cloud engine that can be replicated as needed without affecting the integrity of the n-tier computer application;
generating a first cloud service layer for connecting the interface with the scalable web service enabled application server by the cloud engine;
generating a second cloud service layer for connecting the scalable web service enabled application server with the scalable data store by the cloud engine; and
generating the reconfigured automatically scalable n-tier computer application infrastructure that is horizontally and vertically scalable based on the scalable web service enabled application server, the scalable data store, the first cloud service layer and the second cloud service layer that can run on machines having different computing powers.

3. The method of claim 2, further comprising:
analyzing usage of each of the identified major functional aspects of the n-tier computer application by the first cloud service layer;
optimizing the scalable web service enabled application server based on predetermined rules and the usage analysis by the first cloud service layer;
load balancing and scaling the scalable web service enabled application server based on the optimization by the first cloud service layer; and
refactoring the scalable web service enabled application server based on the load balancing and scaling by the first cloud service layer.

4. The method of claim 3, further comprising:
analyzing usage of each of the identified major database aspects of the data store by the second cloud service layer;
optimizing the scalable data store based on predetermined rules and the usage analysis by the second cloud service layer;
load balancing and scaling the scalable data store based on the optimization by the second cloud service layer; and
refactoring the scalable data store based on the load balancing and scaling by the second cloud service layer.

5. The method of claim 4, further comprising:
managing the n-tier computer application usage via the first cloud service layer and the second cloud service layer based on service usage, optimization, load balancing and service refactoring of the scalable web service enabled application server and the scalable data store.

6. An article comprising a computer readable storage medium having instructions thereon which when executed by a computing platform result in execution of a method for automatic scalability of an n-tier computer application infrastructure, comprising:
identifying major functional aspects of an n-tier computer application by analyzing an n-tier computer application by a cloud engine;
identifying major database aspects in the data store by analyzing a database schema and a data application logic used in the data store by the cloud engine; and
generating a reconfigured automatically scalable n-tier computer application infrastructure that is horizontally and vertically scalable based on the identified major functional aspects, the identified major database aspects and the n-tier computer application usage needs.

7. The article of claim 6, wherein generating the reconfigured automatically scalable n-tier computer application infrastructure comprises:
generating a scalable web service enabled application server, including a application web service for each the identified major functional aspects in the n-tier computer application, by the cloud engine that can be replicated as needed without affecting an integrity of the n-tier computer application;
generating a scalable data store, including a database web service for each the identified major database aspects in the data store, by the cloud engine that can be replicated as needed without affecting the integrity of the n-tier computer application;
generating a first cloud service layer for connecting the interface with the scalable web service enabled application server by the cloud engine;
generating a second cloud service layer for connecting the scalable web service enabled application server with the scalable data store by the cloud engine; and
generating the reconfigured automatically scalable n-tier computer application infrastructure that is horizontally and vertically scalable based on the scalable web service enabled application server, the scalable data store, the first cloud service layer and the second cloud service layer that can run on machines having different computing powers.

8. The article of claim 7, further comprising:
analyzing usage of each of the identified major functional aspects of the n-tier computer application by the first cloud service layer;
optimizing the scalable web service enabled application server based on predetermined rules and the usage analysis by the first cloud service layer;
load balancing and scaling the scalable web service enabled application server based on the optimization by the first cloud service layer; and
refactoring the scalable web service enabled application server based on the load balancing and scaling by the first cloud service layer.

9. The article of claim 8, further comprising:
analyzing usage of each of the identified major database aspects of the data store by the second cloud service layer;
optimizing the scalable data store based on predetermined rules and the usage analysis by the second cloud service layer;
load balancing and scaling the scalable data store based on the optimization by the second cloud service layer; and
refactoring the scalable data store based on the load balancing and scaling by the second cloud service layer.

10. The article of claim 9, further comprising:
managing the n-tier computer application usage via the first cloud service layer and the second cloud service layer based on service usage, optimization, load balancing and service refactoring of the scalable web service enabled application server and the scalable data store.

11. A system for automatic scalability of an n-tier computer application infrastructure, comprising:
a n-tier computer application infrastructure, wherein the computer application infrastructure includes an interface, an application server and a data store, and wherein the n-tier computer application resides on one or more computing machines;
a cloud engine residing in a remote server connected to the n-tier computer application infrastructure via an IP network, wherein the cloud engine identifies major functional aspects of the n-tier computer application by analyzing the n-tier computer application, wherein the cloud engine further identifies major database aspects in the data store by analyzing a database schema and database application logic, and wherein the cloud engine generates a reconfigured automatically scalable n-tier computer application infrastructure that is horizontally and vertically scalable based on the identified major functional aspects, the identified major database aspects and the computer application usage needs.

12. The system of claim 11, wherein the cloud engine comprises:
a code analyzer to identify the major functional aspects of the n-tier computer application by analyzing the n-tier computer application;
a data store refactoring engine to identify the major database aspects in the data store by analyzing the database schema and database application logic; and
a service factory to generate the reconfigured automatically scalable n-tier computer application infrastructure that is horizontally and vertically scalable based on the identified major functional aspects, the identified major database aspects and the n-tier computer application usage needs.

13. The system of claim 12, wherein the service factory generates a scalable web service enabled application server including a application web service for each of the identified functional aspects in the n-tier computer application by the code analyzer, wherein the service factory generates a scalable data store including a database web service for each of the identified major database aspects in the data store by the data store refactoring engine, and wherein the service factory generates a first cloud service layer for connecting the interface with the scalable web service enabled application server, and wherein the service factory further generates a second cloud service layer for connecting the scalable web service enabled application server with the scalable data store.

14. The system of claim 13, wherein the first cloud service layer analyzes usage of each of the identified major functional aspects of the n-tier computer application, wherein the first cloud service layer optimizes the scalable web service enabled application server based on predetermined rules and the usage analysis, wherein the first cloud service layer load balances and scales the scalable web service enabled application server based on the optimization, and wherein the first cloud service layer service refactors the scalable web service enabled application server based on the load balancing and scaling.

15. The system of claim 14, wherein the second cloud service layer analyzes usage of each of the identified major database aspects of the data store, wherein the second cloud service layer further optimizes the scalable data store based on predetermined rules and the usage analysis by the second cloud service layer, and wherein the second cloud service layer further load balances and scales the scalable data store based on the optimization, and wherein the second cloud service layer further service refactors the scalable data store based on the load balancing and scaling.

16. The system of claim 15, further comprising:
a cloud management server connected to the first cloud service layer and the second cloud service layer and wherein the service factory further generates a management interface for each of the first cloud service layer and the second cloud service layer, wherein the generated management interface resides in the first cloud service layer and the second cloud service layer, and wherein the cloud management server manages the computer application usage in the scalable web service enabled application server and the scalable data store via the management interface of the first cloud service layer and the second cloud service layer based on service usage, optimization information, load balancing information and service factoring information obtained from the first cloud service layer and the second cloud service layer.
